(19) United States
(12) Patent Application Publication
(10) Pub. No.: US 2015/0178663 A1
(43) Pub. Date: Jun. 25, 2015

(54) Method and Apparatus For Vehicle Service System Operator Guidance and Performance Tracking

(71) Applicant: Hunter Engineering Company, St. Louis, MO (US)

(72) Inventors: Nicholas J. Colarelli, III, Creve Coeur, MO (US); Michael W. Douglas, St. Charles, MO (US); Timothy A. Strege, Sunset Hills, MO (US)

(21) Appl. No.: 14/560,815

(22) Filed: Dec. 4, 2014

Related U.S. Application Data
(60) Provisional application No. 61/919,385, filed on Dec. 20, 2013.

(51) Int. Cl. G06Q 10/06; G06Q 10/10; G06Q 10/00

(52) U.S. Cl. CPC G06Q 10/06398; G06Q 10/20; G06Q 10/10; G06Q 10/06393

(57) ABSTRACT

A method for providing performance tracking, operator guidance, and feedback by monitoring operator interactions with a vehicle service system. The operator's interactions with the service equipment during a vehicle service procedure which produce detectable effects are monitored. If an operator completes a vehicle service procedure correctly, a visual or audible announcement is provided, and an entry recorded in a system log. If an operator mistake is detected during the vehicle service procedure, a different visual or audible announcement is provided, and a suitable entry recorded in the system log. The system log is subsequently utilized to generate a performance score, either based on overall system usage, or upon the usage by a specific operator if operator-identifying information is available during each service procedure.

### CROSS-REFERENCE TO RELATED APPLICATIONS

The present application is related to, and claims priority from, U.S. Provisional Patent Application Ser. No. 61/919,385 filed on Dec. 20, 2013, and which is herein incorporated by reference.

### STATEMENT REGARDING FEDERALLY SPONSORED RESEARCH

Not Applicable.

### BACKGROUND OF THE INVENTION

The present invention is related generally to methods for educating an operator of a vehicle service system such as, but not limited to, a wheel balancer, a tire changer, or wheel alignment system, and in particular to methods and apparatus for providing operator guidance, feedback, and performance tracking to increase operator skill and efficiency during vehicle service procedures which require operator interaction.

Most automotive vehicle service systems, such as vehicle wheel balancers, tire changers, and wheel alignment measurement systems, require an operator to carry out various tasks during the course of a service procedure. Ultimately, the end result of the service procedure, which may be the acquisition of measurements, the mounting of a tire to a wheel rim, the correction of a wheel assembly imbalance, or the adjustment of a vehicle alignment angle, are sensitive to the ability of the operator to perform the required tasks with a necessary degree of accuracy, efficiency, or in a required sequence. Failure of the operator to properly carry out the required tasks, or inattention to detail while completing a required task, can result in a failure of the service procedure or a poor service result, necessitating that the procedure be restarted or repeated. In an automotive service shop, waiting customers and tight schedules can be significantly impacted by poor operator performance which results in delays such as restarted or repeated service procedures. These problems can be exacerbated in automotive service shops which have a high rate of employee turn-over, such as tire shops or limited service shops, which frequently employ seasonal workers such as students during summer months, who have little time to learn the necessary skill and vehicle service procedures.

For example, during a vehicle wheel balancing procedure, an operator must carry out multiple steps during the balancing procedure with precision. These include the initial mounting and clamping of the wheel assembly to the balancer spindle shaft, removing previously installed imbalance correction weights, the selection of identified imbalance correction weights from the on-hand inventory, and the proper placement of the selected imbalance correction weights onto the vehicle wheel assembly as directed by the vehicle wheel balancer. If the operator fails to properly center and/or clamp the wheel assembly to the balancer spindle shaft when beginning the imbalance measurement procedures, the wheel assembly may slip relative to the shaft axis, and applied weights will not properly compensate for the imbalance present in the wheel assembly. Failure to properly compensate for the imbalance in a wheel assembly may potentially result in the wheel assembly causing vibrations when remounted to a vehicle, necessitating the imbalance measurement procedures be redone or additional weights be applied. Following an imbalance correction procedure, a wheel assembly may fail a check-spin procedure if the operator failed to apply the correction amount of weight previously identified by the balancing system, or failed to apply the imbalance correction weights at the proper axial and angular locations on the vehicle wheel assembly as directed by the balancing system. The end result is either wasted time resolving the initial fault of the operator, or an unsatisfied customer.

In another example, during a vehicle wheel alignment measurement procedure being conducted with an alignment measurement system requiring wheel-mounted sensors or targets, an operator must securely mount the sensors or targets to the vehicle wheel assembly. Failure to properly secure the sensors or targets to the vehicle wheels can result in the sensor or target moving relative to the wheel assembly on which it is mounted during the measurement procedures, resulting in an inaccurate measurement, potentially causing the alignment measurement system to call for adjustments to the vehicle suspension which are incorrect or un-necessary.

In yet another example, during a tire changing operation, an operator is required to properly mount and clamp a wheel rim to a spindle shaft of the tire changer, and may be required during the procedure to rotate the mounted wheel rim to a specific position (such as referenced to the location of the valve stem). Failure to properly clamp or position the wheel rim can result in a wide range of problems, including, but not limited to, failure to properly dismount a tire from the rim, damage to a tire or rim, damage to articulated tool components of the tire changer, and/or damage to an installed tire pressure monitor associated with the wheel rim. Failure of the operator to properly follow instructions from the tire changer, deviating from a specific procedure, or needing to restart a procedure can result in wasted time and expense.

Accordingly, there is a need in the automotive service industry to provide operator guidance, feedback, and overall performance tracking associated with vehicle service equipment, to increase operator awareness, and to increase operator efficiency during vehicle service procedures which require operator interaction.

### BRIEF SUMMARY OF THE INVENTION

Briefly stated, the present disclosure sets forth a method for providing operator guidance, feedback, and overall performance tracking by directly and indirectly monitoring operator interactions with a vehicle service system. The detectable effects of an operator's required interactions with the service equipment during a vehicle service procedure are monitored, and any deviations from an acceptable or expected response are recorded or logged. If an operator completes a vehicle service procedure correctly, a visual or audible announcement is provided as positive feedback, and an entry recorded in a system log or data store. If an operator mistake or unexpected action is detected during the vehicle service procedure, a different visual or audible announcement is provided as negative feedback, and a suitable entry recorded in the system log or data store. The contents of the system log may be subsequently utilized to generate a performance score or metric, either based on overall system usage by a group of operators, or upon the usage by a specific operator if operator-identifying information is available during each service procedure. These scores or metrics may be used in conjunction with either a self-motivating or an incentive-based operator training system to encourage operators to learn how to quickly and efficiently operate the vehicle service system in a correct and efficient manner to maximize performance.

The foregoing features, and advantages set forth in the present disclosure as well as presently preferred embodiments will become more apparent from the reading of the following description in connection with the accompanying drawing.

### BRIEF DESCRIPTION OF THE SEVERAL VIEWS OF THE DRAWING

In the accompanying drawing which form part of the specification:

FIG. 1 is a flow chart illustrating a method of the present disclosure in a vehicle service system.

Corresponding reference numerals indicate corresponding parts throughout the FIGURE of the drawing. It is to be understood that the drawing is for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawing.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

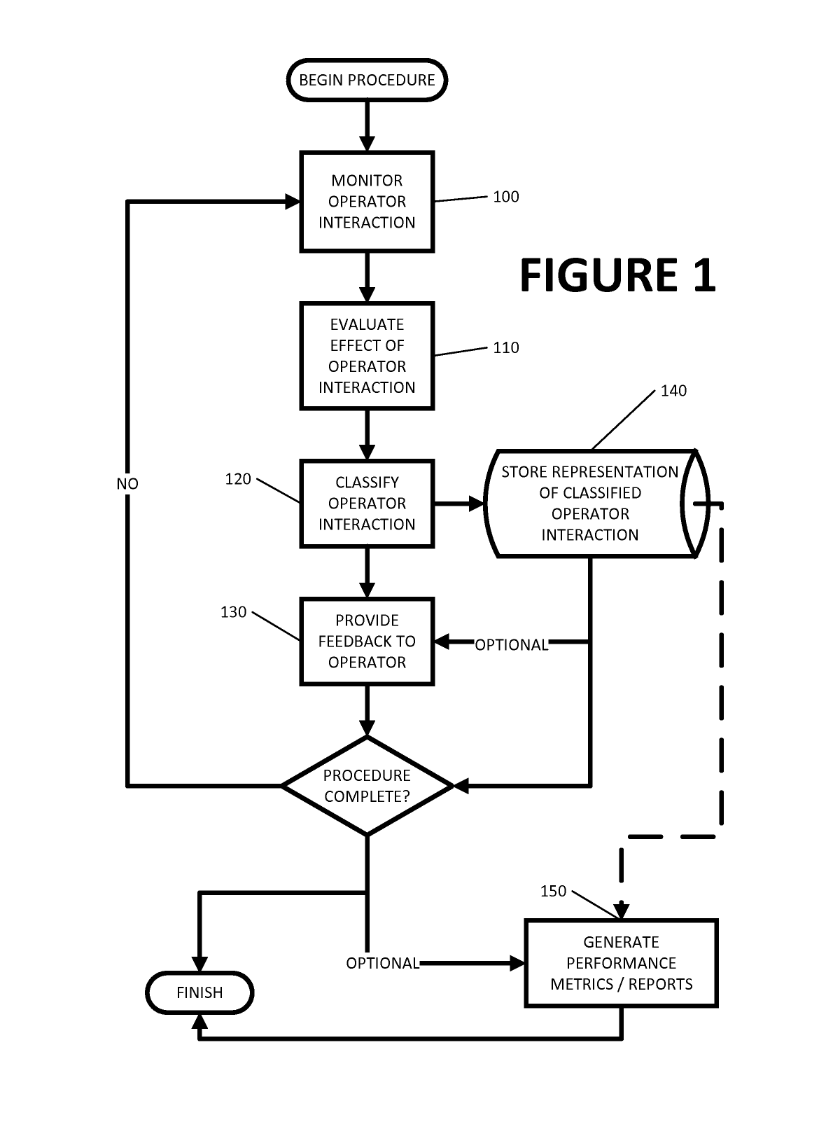

In broad embodiment as shown in FIG. 1, the present disclosure provides a method for tracking and/or improving performance associated with the operation of vehicle service system, either individually per operator, or generally as a compilation of the performance of various operators. During a vehicle service procedure, one or more operator interactions with the vehicle service system which produce detectable effects on the service procedure are monitored by the vehicle service system (Box 100). These interactions may include, but are not limited to, the completion of specific steps in a service procedure, the completion of a sequence of actions in a service procedure, adherence to operational requirements of the vehicle service system, efficiency, and performance of routine maintenance and/or calibration procedures. Preferably, the vehicle service system includes a processor which is configured with software instructions to receive input representative of the detectable effects of an operator interaction with the vehicle service system. These detectable effects may include, but are not limited to, measurement results, detection of operator-induced problems, operator inputs, and operator queries, as well as procedural initiations, procedure retries, procedure restarts, and completions of specific procedures.

The processor is further configured with software instructions to evaluate the detectable effects (Box 110) to classify or categorize the monitored operator interaction (Box 120) as either correct and acceptable, or incorrect and unacceptable, and in one embodiment, provide a corresponding visual or audible announcement or feedback to the operator (Box 130). The visual or audible announcement to the operator is intended to serve as a motivational tool, either providing positive feedback in the event an operator has completed an action in an correct or acceptable manner, or providing a negative feedback indicating the operator has incorrectly interacted with the vehicle service system or has failed to achieve an acceptable result, such as due to error or inattention to detail.

Once classified or characterized, a record of the evaluated operator interactions may optionally be stored by the processor in an accessible data store (Box 140), either locally or at a remote location via a suitable communication link. The processor of the vehicle service system, may optionally be configured with software instructions to use the stored data as needed to generate and report various metrics (Box 150) associated with either the performance of individual operators using the vehicle service system over time, or as a compilation of the performance of a group of operators over a period of time. These metrics may include comparative rankings between individual operators or identification of performance trends for individual operators or groups of operators using the vehicle service system, promoting friendly competition within a service shop for operators to achieve the highest rankings. Metrics may further consist of comparisons between the performance of individual operators or groups of operators and established goals or standards. The goals or standards may be established by operators themselves, such as for self-motivation; by shop management, such as for evaluating shop efficiency, or as industry accepted standards, industry recognized best-practice values, or industry reported averages.

Preferably, the metrics generated by the processor are selected to either motivate or educate individual operators in how to improve performance when interacting with the vehicle service system. The specific metrics which are generated may further be selected to provide service shop management with information which is useful for evaluating operator performance (e.g., frequency of operator mistakes, procedure restarts, incorrect selections, etc.), productivity (e.g., speed with which procedures are completed by operators), and utilization of the vehicle service system (e.g., how frequently are available procedures utilized on the vehicle service system). For example, a report may be generated indicating, as a percentage of completed procedures, how often each individual operator was required to restart a procedure, correct the placement of installed imbalance correction weights, or re-tighten the mounting of a wheel assembly to a balancer spindle shaft, etc. The time required for individual operators to complete various procedures may be tracked and presented in a report for comparison against other operators and to quantify operator productivity. Accordingly, it is preferable that the stored data be accessible by external systems such as by means of download, direct access, network communications, or periodic reporting functions.

In a further embodiment, the processor of the vehicle service system is configured to use one or more of the various metrics associated with either the performance of individual operators using the vehicle service system over time, or a compilation of the performance of a group of operators over a period of time, to attempt to improve operator performance. Responsive to the metrics, the processor of the vehicle service system is configured with software instructions to automatically alter a procedure or setting on of the vehicle service system, or to present the operator with a suggested procedural change or setting change to alter the operation of the vehicle service system. For example, if an individual operator is identified as consistently having difficulty completing a specific task (based on a poor metric score associated with the specific task), the processor of the vehicle service system may, upon identifying the persistent condition, automatically switch to a different mode of operation for that operator, provide additional guidance for that operator during the specific task, suggest altered operating parameters for that operator, or automatically change an operating parameter for that operator, such as by introducing a compensation variable.

Those of ordinary skill in the art will recognize that the general methods and apparatus for tracking the performance of individual operators or groups of operators associated with a vehicle service system may be implemented in a variety of different types of vehicle service systems without departing from the scope of the present disclosure.

For example, in one embodiment of the present disclosure, a processing system of a vehicle wheel balancer is configured with suitable software instructions to implement the methods for tracking the service system interactions and performance of individual operators, or groups of operators, associated with the operation of the vehicle wheel balancer. In a vehicle wheel balancer system, such as shown in U.S. Pat. No. 6,435,027 B1 to Colarelli, III et al., herein incorporated by reference, these monitored operator interactions may include, but are not limited to, the proper centering of a wheel assembly on a spindle shaft of the balancer, proper clamping the wheel assembly to the spindle shaft, correct identification of the wheel assembly parameters by the operator, selection of identified imbalance correction weights by the operator after an imbalance measurement, placement of the identified imbalance correction weights onto a surface of the vehicle wheel assembly after an imbalance measurement, and avoidance of interfering contact between the operator and components of the vehicle wheel balancer during an imbalance measurement.

The various operator interactions may be monitored by the processor of the vehicle wheel balancer as modified by suitable software instructions, either directly, such as through various sensors which receive input directly associated with the operator interactions, or indirectly, such as through the results of imbalance measurements or imbalance corrections for the vehicle wheel assembly.

For example, following measurement of the imbalance of a vehicle wheel assembly, the processor of the vehicle wheel balancer is configured with software instructions to identify to an operator the amount of imbalance correction weight to apply to the vehicle wheel assembly and the location(s) at which the correction weight should be applied on the wheel assembly surface. If the operator fails to apply the correct amount of imbalance correction weight (i.e. fails to select a proper incremental weight unit or length of adhesive weight strip), if the operator fails to install the imbalance correction weight at the correct location(s), or if the operator fails to install the imbalance correction weight in a specific configuration as instructed, the mistakes will be detected by the vehicle wheel balancer processor during a subsequent check-spin procedure intended to confirm the imbalance correction. Mistakes associated with imbalance correction weight installation may additionally be detected by the vehicle wheel balancer processor configured with software instruction to use various sensors for scanning features, such as installed imbalance correction weights, on wheel rim surfaces. Detected mistakes are classified as incorrect and unacceptable actions by the operator, while wheel assemblies which successfully pass the check are identified as the result of operator actions (associated with imbalance correction weight selection and placement) which are correct and acceptable.

Similarly, an initial operator interaction with the wheel balancer system such as the process of clamping the wheel assembly to the spindle shaft can be monitored by the balancer processor configured with suitable software and sensors to measure wheel assembly slip relative to the spindle shaft, such as shown in co-pending U.S. Patent Application Publication No. 2014-0165721 A1, which is herein incorporated by reference. If slip is detected by the processor before, during, or after the imbalance measurement process, a likely cause of the problem is a failure of the operator to properly mount or clamp the wheel assembly to the balancer spindle shaft. This problem is identified by the suitably configured processor, and logged accordingly together with any appropriate feedback provided to the operator.

The processor of the wheel balancer may be configured with software instructions to monitor, during the course of a vehicle wheel imbalance measurement procedure, the number of times the operator interrupts or restarts a procedural sequence, repeats a procedural step, or resets the imbalance measurement procedure. In general, interrupts, restarts, repeats, and resets of procedures are considered to be indications of poor operator performance or training, and may be classified as such by the processor when storing operator performance metrics or providing operator feedback.

Within a wheel balancer system, individual operator training can be improved by providing feedback (either positive or negative) following the classification of a monitored operator interaction by the wheel balancer processor. This feedback may be the presentation of a visual display on a display device operatively coupled to, and controlled by the processor of the wheel balancer, or the presentation of an audible tone, announcement, or melody, such as a bell or chime via an audio output device operatively coupled to and controlled by the processor of the wheel balancer. The feedback may be immediate upon the classification of the interaction by the processor, or may be provided at a subsequent point in time, such as with a report on the operator's overall performance at the completion of the procedures being carried out.

Classification results from the various monitored operator interactions are stored by the processor of the vehicle wheel balancer in an accessible data store, either locally or at a remote location via a suitable communication link, such as a Wi-Fi link or suitable internet connection. The vehicle wheel balancer processor may be configured with software instructions to use the stored classification results to locally generate and report various metrics associated with the performance of individual operators using the vehicle wheel balancer over time (suitable for use where individual operators are identifiable), or as a compilation of the performance of a group of operators using the vehicle wheel balancer over a period of time (suitable for use where individual operators are not tracked or identified). Optionally, the contents of the data store may be accessed by outside systems, such as shop management systems, for trend tracking and operator performance monitoring.

The metrics tracked for trends and operator performance may include comparative rankings between individual operators or identification of performance trends for the individual operators or the group of operators using the vehicle wheel balancer, promoting friendly competition within a service shop for operators to achieve the highest rankings. Preferably, the metrics generated by the processor of the vehicle wheel balancer, and the manner in which they are reported or announced, are selected to motivate or educate individual operators in how to improve performance when interacting with the vehicle wheel balancer. Alternatively, or in addition, the specific metrics which are generated may be selected to provide service shop management with information which is useful for evaluating employee performance, productivity, and utilization of the vehicle wheel balancer, enabling shop management to identify employees in need of additional training, or of specific wheel balancing procedures which have a higher rate of operator problems For example, evaluation of the specific metrics may identify a single operator who consistently has trouble with successfully clamping wheel assemblies to the balancer shaft (as indicated by a large number of detected wheel slip occurrences. Similarly, evaluation of the specific metrics may indicate that a number of operators are all having trouble with correct placement of adhesive-style imbalance correction weights, suggesting that the shop workforce may benefit from additional training related to the operation of the vehicle wheel balancer system.

Optionally, the processor of the vehicle wheel balancer may be configured with software instructions to use one or more of the various metrics associated with either the performance of individual operators using the vehicle wheel balancer over time, or a compilation of the performance of a group of operators over a period of time, to attempt to improve operator performance. Responsive to the metrics, the processor may be configured to automatically alter a procedure or setting on of the vehicle wheel balancer, or to present the operator with a suggested procedural change or setting change to alter the operation of the vehicle wheel balancer. For example, if an individual operator is identified as consistently having difficulty completing a specific task such as the proper placement of an imbalance correction weight (based on a poor metric score associated with the specific task), the processor of the vehicle wheel balancer may, upon identifying a consistent repeated error in the operator's placement location for the imbalance correction weight, provide additional guidance for that operator during weight placement, suggest the use of an offset to compensate for the consistent repeated error in placement, or automatically insert an offset when directing the operator to place imbalance correction weights on the vehicle wheel assembly.

In a further embodiment of the present disclosure, a processing system of a vehicle wheel alignment system is configured with suitable software instructions to implement the methods for tracking the performance of individual operators or groups of operators involved in the operation of the vehicle wheel alignment system. In a vehicle wheel alignment system, exemplary monitored operator interactions may include, but are not limited to, the mounting of an alignment sensor or an optical target to a vehicle wheel assembly, the runout compensation of a mounted alignment sensor or optical target, the application of vehicle brakes at correct points in a vehicle alignment measurement procedure, control of vehicle movement during a wheel alignment measurement procedure, and the correct adjustment of vehicle alignment angles during a wheel alignment measurement procedure.

The various operator interactions may be monitored by a suitably configured processor of the vehicle wheel alignment system either directly, such as through various sensors which receive input directly associated with the operator interactions, or indirectly through monitored alignment related measurements or observed alignment adjustments associated with a vehicle.

For example, in one configuration of a vehicle wheel alignment system, angle sensors or optical targets must be mounted to the vehicle wheel assemblies using adapters. The mounting of these adapters must be properly compensated for axial misalignment with the axis of rotation for the associated wheel assembly on which they are disposed, such as described in U.S. Pat. No. 7,974,806 B1 to Burns et al. Once compensated, the mounting relationship between the adapter and the wheel assembly must remain unchanged during the remainder of the vehicle wheel alignment measurement procedures. If an operator fails to properly secure the adapters to the vehicle wheel assembly, slippage or movement may occur, resulting in erroneous alignment related measurements, and necessitating a restart of the measurement procedure. Detected mistakes associated with the mounting of the adapters are classified by the processor of the wheel alignment system as incorrect and unacceptable interactions by the operator.

During the course of a vehicle alignment service, an operator may be required to manually roll the vehicle a short distance along a straight path, to manually steer the vehicle steered wheels smoothly through a range of motion, or to lock the vehicle wheels against rotation by applying the vehicle brakes. By monitoring the movement of the angle sensors, optical targets, or various measurements acquired during the vehicle alignment service, the processor of the vehicle wheel alignment system can detect if the operator fails to maintain the vehicle along a straight path when required, if the operator steers the vehicle wheels too fast or too far during a directed steering movement, or if the operator fails to lock the vehicle wheels when required. Detected mistakes such as these associated with the acquisition of vehicle measurements are classified by the processor as incorrect and unacceptable interactions by the operator.

The wheel alignment system processor may be configured with software instructions to monitor, during the course of a vehicle wheel alignment inspection or measurement procedure, the number of times the operator interrupts or restarts a procedural sequence, repeats a procedural step, or resets the wheel alignment measurement procedure. In general, interrupts, restarts, repeats, and resets of procedures are considered to be indications of poor operator performance, and may be classified as such by the processor when storing operator performance metrics.

Within a vehicle wheel alignment or inspection system, operator training can be improved by providing immediate feedback (either positive or negative) following classification of a monitored operator interaction. This immediate feedback may be a presentation of a visual display on a display device operatively coupled to, and controlled by, the alignment system processor, or the presentation of an audible tone, announcement, or melody, such as a bell or chime via an audio output device operatively coupled to, and controlled by, the alignment system processor.

Classification data from the various monitored operator interactions is stored by the processor of the vehicle wheel aligner or inspection system in an accessible data store, either locally or at a remote location via a suitable communication link, such as a Wi-Fi link or suitable internet connection. The alignment system processor may be configured with software instructions to use the stored classification data to locally generate and report various metrics associated with the performance of individual operators using the vehicle wheel alignment or inspection system over time (suitable for use where individual operators are identifiable), or as a compilation of the performance of multiple operators of the vehicle wheel alignment system over a period of time (suitable for use where individual operators are not tracked or identified). Optionally, the contents of the data store may be accessed by outside systems, such as a shop management system, for trend tracking and performance monitoring.

The metrics tracked for trends and performance may include comparative rankings between individual operators, or the identification of performance trends for individual operators or the group of operators using the vehicle wheel alignment or inspection system, with the intent of promoting friendly competition within a service shop setting for operators to achieve the highest rankings. Preferably, the metrics generated by the wheel alignment system processor, and the manner in which they are reported or announced, are selected to motivate or educate individual operators in how to improve performance when interacting with the vehicle wheel alignment or inspection system.

Alternatively, the specific metrics which are generated may be selected to provide service shop management with information which is useful for evaluating operator performance, productivity, and utilization of the vehicle wheel alignment or inspection system, enabling shop management to identify operators in need of additional training, or to identify specific measurement or inspection procedures which have a higher rate of operator problems For example, evaluation of the specific metrics may identify a single operator who consistently has trouble with successfully clamping sensors or optical targets to the vehicle wheels (as indicated by a large number of detected adapter slip occurrences. Similarly, evaluation of the specific metrics may indicate that a number of operators are all having trouble with correctly rolling the vehicle in a straight line during a compensation procedure, suggesting that the shop workforce may benefit from additional training.

Optionally, the processor of the wheel alignment system may be configured with software instructions to use one or more of the various metrics associated with either the performance of individual operators using the wheel alignment system over time, or a compilation of the performance of a group of operators over a period of time, to attempt to improve operator performance. Responsive to the metrics, the processor may be configured to automatically alter a procedure or setting on of the wheel alignment system, or to present the operator with a suggested procedural change or setting change to alter the operation of the vehicle wheel alignment system. For example, if an individual operator is identified as consistently failing to complete a required step in an alignment procedure, such as the application of the vehicle brakes before measurement (based on a poor metric score associated with the specific task), the processor of the vehicle wheel alignment system may, upon identifying the consistently repeated error, provide additional warnings to the operator to lock the vehicle brakes.

Those of ordinary skill in the art will recognize that the inventive aspects of the present disclosure are not limited to use on vehicle wheel balancer and vehicle wheel alignment systems as set forth the exemplary embodiments above. Other vehicle service systems which require operator interaction can benefit from the inventive aspects of the present disclosure. For example, vehicle tire changers may be configured to monitor operator interactions to determine if an operator correctly follows provided instructions and completes a tire change operation without restarts, retries, or miss-steps. The occurrences of transitions from automatic modes of operation to manual modes of operation can be tracked, as can pauses during tire change operations, and overall tire change cycle times, which can be evaluated to provide indications of operator performance. Similarly, vehicle inspection systems, such as alignment quick-checks, brake checks, and drive-over tire tread depth system can benefit from the inventive aspects of the present disclosure by monitoring operator interactions in the form of properly followed procedures (i.e., correctly driving the vehicle over sensors, correctly steering the vehicle per instructions, correctly mounting sensors, etc.) as well as the amount of time taken by an operator to complete the procedure.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes a specialized apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes a specialized apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawing shall be interpreted as illustrative and not in a limiting sense.

1. A method for tracking operator performance associated with the operation of vehicle service system, comprising:
monitoring at least one operator interaction with the vehicle service system having a detectable effect during a vehicle service procedure;
evaluating said detectable effect to categorize the operator interaction with the vehicle service system; and
generating at least one metric of performance from said categorized operator interactions.

2. The method of claim 1 wherein said operator interaction is categorized according to a set of categories including correct, acceptable, incorrect, and unacceptable.

3. The method of claim 2 further including the step of providing a visual or audible feedback signal to an operator corresponding to the categorization of said operator interaction with the vehicle service system.

4. The method of claim 1 wherein said metric of performance is a performance score reflecting either an individual operator's interactions, or a collection of operator interactions with the vehicle service system.

5. The method of claim 4 further including the step of ranking said performance score relative to one or more previously obtained performance scores, and providing an indication of said ranking.

6. The method of claim 4 further including the step of comparing said performance score with a goal or standard, and providing a signal representative of said comparison.

7. The method of claim 1 further including storing said categorized operator interactions in an accessible data log; and
reviewing said data log of categorized operator interactions with the vehicle service system to identify and report at least one comparison, trend, or pattern associated with operator performance during operation of said vehicle service system, operator productivity during operation of said vehicle service system, or operator utilization of said vehicle service system.

8. The method of claim 7 further including, responsive to an identified trend or pattern associated with said operator performance during operation of said vehicle service system, altering an operation of said vehicle service system.

9. The method of claim 1 wherein the monitored operator interaction is one of a set of operator interactions including operator implementation of sequential steps in a vehicle service procedure, operator adherence to operational requirements of the vehicle service system during a vehicle service procedure, operator efficiency in completing a vehicle service procedure, and operator completion of maintenance and/or calibration procedure required for operation of said vehicle service system.

10. The method of claim 1 wherein said detectable effect is one of a change in a measured value observed by the vehicle service system, an operator input to the vehicle service system, an operator query to the vehicle service system, initiation of a vehicle service procedure, a vehicle service procedure retry, or completion of a vehicle service procedure.

11. The method of claim 1 wherein the vehicle service system is a vehicle wheel balancer, and wherein the monitored operator interaction is selected from a set of interactions including centering a wheel assembly on a spindle shaft, clamping a wheel assembly to a spindle shaft, identification of wheel assembly parameters, selection of an imbalance correction weight, placement of an imbalance correction weight onto a surface of a vehicle wheel assembly, and occurrence of interfering physical contact between an operator and a component of the vehicle wheel balancer during an imbalance measurement procedure.

12. The method of claim 1 wherein the vehicle service system is a vehicle wheel alignment system, and wherein the monitored operator interaction is selected from a set of interactions including mounting of a sensor or a target to a vehicle wheel assembly, compensation of a mounted sensor or target, application of vehicle brakes, controlling vehicle movement during a wheel alignment measurement procedure, and adjustment of an alignment angle during a wheel alignment measurement procedure.

13. The method of claim 1 wherein the vehicle service system is a tire changing system, and wherein the monitored operator interaction is selected from a set of interactions including securing a wheel assembly, restarting a service procedure, requests for assistance, and transitions between automatic and manual modes of operation.

14. A vehicle service system including a processor configured with software instructions to interact with an operator and to carry out a vehicle service procedure, comprising:
wherein the processor is configured with software instructions to evaluate a detectable effect of at least one operator interaction with the vehicle service system, and to categorize the operator interaction with the vehicle service system; and
wherein the processor is configured with software instructions to generate at least one metric of performance from said categorized operator interactions.

15. The vehicle service system of claim 14 wherein said processor is further configured to categorize said operator interaction according to a set of categories including correct, acceptable, incorrect, and unacceptable.

16. The vehicle service system of claim 15 wherein said processor is operatively coupled to a means for providing a feedback indication of said categorization of said operator interaction to said operator, said feedback indication including at least one of a visual indication and an audible indication.

17. The vehicle service system of claim 14 wherein said metric of performance is representative of either an individual operator's interactions, or representative of a collection of operator interactions with the vehicle service system.

18. The vehicle service system of claim 17 wherein said processor is further configured with software instructions to rank said performance score relative to one or more previously obtained performance scores, and to providing an indication of said ranking.

18. The vehicle service system of claim 17 wherein said processor is further configured with software instructions to compare said metric of performance with a goal or standard, and to providing an output representative of said comparison.

19. The vehicle service system of claim 14 wherein said processor is configured with software instructions to maintain a log of categorized operator interactions within an accessible data store; and
wherein said processor is further configured with software instructions to review said log of categorized operator interactions with the vehicle service system to identify at least one comparison, trend, or pattern associated with operator performance, and to providing an indication of said identified comparison, trend, or pattern.

20. The vehicle service system of claim 19 wherein said processor is configured with software instructions responsive to an identified trend or pattern associated with said operator performance during operation of said vehicle service system, to alter an operation of said vehicle service system related to said operator performance.

21. The vehicle service system of claim 14 wherein said vehicle service procedure is one of a tire change procedure, a wheel assembly balance procedure, a vehicle alignment procedure, a vehicle quick-check service procedure, a tire tread depth measurement procedure, or a vehicle brake check procedure.
